(19) United States
(12) Patent Application Publication
(10) Pub. No.: US 2020/0180737 A1
(43) Pub. Date: Jun. 11, 2020

(54) SHIP FOR RECOVERING OCEAN WASTE

(71) Applicant: Serge MENARD, Saint-Julien-de-Gras-Capou (FR)

(72) Inventor: Serge MENARD, Saint-Julien-de-Gras-Capou (FR)

(21) Appl. No.: 16/637,485

(22) PCT Filed: Aug. 7, 2018
(86) PCT No.: PCT/EP2018/000391

§ 371 Date: Feb. 7, 2020

(30) Foreign Application Priority Data
Aug. 7, 2017 (FR) 17/00842

(51) Int. Cl. B63B 35/32; B63B 49/00; B63H 11/00; A01M 19/00

(52) U.S. Cl. CPC B63B 35/32; A01M 19/00; B63H 11/00; B63B 49/00

(57) ABSTRACT

The present invention relates to a ship for recovering ocean waste. The ship for recovering ocean waste according to the invention has at least one tank (3) that passes through the ship from the prow (6) to the stern (7), the tank (3) being open at its two ends and being equipped with at least one row (10, 20, 30, 40, 50, 60, 70) of collecting devices (8). The ship according to the invention is characterized in that the collecting devices (8) of at least one row are disposed such that they have openings (5) or spaces (5) between one another. This disposition of the collecting devices allows fish to pass easily through the rows of devices, while waste is collected efficiently.

The present invention relates to a ship for recovering ocean waste.

Over a vast expanse of the North Pacific, usually estimated at 3.5 million square kilometers, is concentrated a “soup” that experts estimate has accumulated several millions of tons of plastic debris and is floating between two waters, in a layer of a thickness of 10 to 30 meters.

This layer of the North Pacific is the world's largest waste dump, held in place by ocean currents, whose growth projections made in 2008 already suggested that it could double in size in the next decade.

In 2006, oceanographer Charles Moore discovered this garbage vortex zone, consisting of non-biodegraded garbage, some since 50 years, undetectable by satellites because it circulates below the surface of the water, composed of 90% of plastics, as is the case for the global volume of all the garbage floating in the oceans.

This threat is also evident for marine ecosystems, this polluted area of the Pacific being the manifestation of a phenomenon that affects all the oceans of the planet, as this waste floats in all the seas, including the polar regions. In some places, there is more plastic waste than plankton.

The unavoidable clean-up of these polluted areas therefore ultimately represents a titanic task that can only be the responsibility of the international community in the broadest sense. The clean-up of the oceans is inevitable and urgent. A persistent worsening of the situation would lead to an irreversible planetary catastrophe.

A ship for recovering ocean waste is described in WO 2014/111 258 A2. This ship comprises a basin in which waste pick-up devices are arranged across the entire width of the ship.

The ship for recovering ocean waste according to the invention comprises at least one basin passing through the ship from bow to stern, the basin being open at both ends and being equipped with at least one row of pick-up devices.

The ship according to the invention is characterized in that the pick-up devices of at least one row are arranged in such a way that they have openings or spaces between them. This arrangement of the pick-up devices allows fish to pass easily through the rows of devices, while the waste will be collected efficiently.

Advantageously, beams or hoods or fairings can be positioned in front of the openings or spaces between the pick-up devices, preferably over the entire row of devices, to prevent the passage of waste by deflecting it towards the pick-up devices, while allowing fish to pass easily through these spaces or openings. Depending on the arrangement of the spaces, the beams or covers may be vertical or horizontal.

Beams or hoods or fairings can preferably be shaped to guide the waste to one or more pick-up devices. They may also be flat in shape provided that they are preferably oriented at an angle to the direction of travel of the ship to deflect waste that strikes the beam or hood or fairing towards a pick-up device.

The distance between a beam or hood or fairing and the row of pick-up devices can be chosen according to the size of the objects to be picked up by the pick-up devices. The distance may, for example, be between 50 cm and 2 m for a pick-up device designed to pick up medium-sized objects.

Advantageously, the pick-up devices can be arranged vertically and/or horizontally staggered, offset or at an angle to the direction of travel of the ship.

Preferably, the pick-up devices can be arranged overlapping at their edges. In particular, if the pick-up devices are arranged offset, the edges of the devices located further forward may overlap the edges of the devices located behind them, leaving a gap between them.

In particular, the dimension of the space between the edges of two adjacent devices may be less than two meters and preferably less than one meter.

The costs of acquiring the pick-up devices, the labor required for handling operations or intervention on the devices and the costs of servicing and maintenance are directly proportional to the number of devices used. In order to reduce the number of devices required for the ship's mission by maintaining the width of the treated water layer, it is advantageous that the width of the basin opening at the bow of the ship is greater than the width of the basin at the location of at least one row of pick-up devices. For example, the shape of the hulls may be adapted or internal walls or hulls that reduce the internal width of the ship's basin may be inserted so that the width of the basin opening at the bow of the ship is greater than the width of the basin at the location of at least one row of pick-up devices.

Advantageously, the width of the basin at the location of at least one row of pick-up devices corresponds to less than 60%, advantageously to less than 40% and in particular to less than 30% of the width of the opening of the basin at the bow of the ship.

For example, the width of the layer of water trapped can be increased for a given ship's breadth, by optimizing the shape of the bow tips of the outer hulls by moving them as far outwards as possible, thus maintaining the ship's breadth and widening the width of the layer of water trapped.

The hulls can also be fitted with bow extensions that extend outwards beyond the width of the ship to increase the width of the layer of water trapped.

It is also possible to provide internal walls or an internal hull in the basin, which reduces the width of the basin at the level of the pick-up devices, in order to keep a large treatment width and to limit the width of the pick-up devices.

The basin of a ship according to the invention may comprise at least two successive sections from the bow to the stern of the ship. The pick-up devices of each section may be capable of collecting objects of a specific and different size range for each section. The sections may be arranged in such a way that a device capable of picking up smaller objects is arranged behind a device capable of picking up larger objects in relation to the direction of movement of the ship.

The pick-up devices may be held and guided by means of supports, in particular by cables, chains, tubes and/or beams, profiled or non-profiled. The pick-up devices may be wholly or partly composed of nets or latticework, and be equipped with rings or any other fastening devices enabling them to slide or move along the supports.

The pick-up devices, in particular in the first area of the front section of the ship, may consist of coarse-meshed nets or lattice, made of wire rope or metal mesh or any other material having sufficient solidity. At the bottom of the nets or lattice, a horizontal platform may be provided, constituting a protrusion connected to the bottom of the net or lattice, allowing hauling up the waste floating at different depths. This platform may be constituted by an extension of the net or lattice, forks or a metal platform. In another version, the waste lifting platform is independent of the net or lattice.

The pick-up devices may also consist of wire mesh skips, rotating conveyor belts, in particular comprising lifting means attached to or independent of the conveyor belt, in particular lifting shovels, wire mesh skips or fixed or articulated hooks.

The pick-up devices can preferably be lifted and/or retracted and/or removed. According to a particularly advantageous embodiment of the invention, at least one section is equipped with at least two successive pick-up devices. In this configuration, one device can be lifted up, for example for maintenance reasons or because it is blocked by a collected object, and the second device can ensure collection in the meantime and can prevent waste of an unsuitable size from arriving in the next section.

The motirization of the ship can preferably be a diesel-electric hybrid hydrogen engine running partly or wholly on hydrogen. In particular, the ship may be equipped with one or more engines running on hydrogen. The hydrogen needed to run the engine(s) can advantageously be produced on board, for example by means of a power unit, fuel or solar batteries, feeding an electrolyzer which injects hydrogen directly or indirectly into the engine(s). Hydrogen can preferably be produced as and when required.

The production capacity of the hydrogen production device may, for example, be sufficient to inject at least 50% of the hydrogen needed to operate the engine(s), preferably at least 70%, and advantageously at least 100% of the hydrogen needed. If the production of hydrogen is greater than the consumption of the engine(s), the hydrogen may be stored in a buffer tank or may be used for other purposes, e.g. for power supply to the ship's deck or other equipment.

The ship according to the invention may be equipped with water jet propulsion means. This makes it possible to pass over nets, trawls, ropes and other debris without the risk of damaging the propeller.

The ship for recovering waste may also recover from the ocean marine animals that are occasionally and/or locally classified as pests, in particular jellyfish. In this case, the ship may preferably comprise at least one device for the treatment of such animals. The treatment device may e.g. be equipped with a high-temperature heating device to kill these pests. Such a device may, for example, be located on the working deck of the ship and may comprise an open container or an enclosed space, equipped with a high-temperature heating device, with or without flames, to kill the pests, or to incinerate them by cremation.

The ship according to the invention may comprise at least one electronic device for displaying images or video films in the form of a flat, convex, concave, spherical or other shaped panel or screen. This device may, for example, be fixed to the sides of the ship to display advertising. Such a panel may have very large dimensions, for example a width of 60 m or more. The panel or screen may preferably be retractable or may be stored in a protective housing or may be equipped with a retractable or removable protective watertight cover. This allows the device to be protected when not in use or in adverse weather conditions.

The ship may be equipped with a device for representing holographic images or video films.

The invention is explained more precisely below with reference to the attached figures which show embodiments of the invention in a schematic manner:

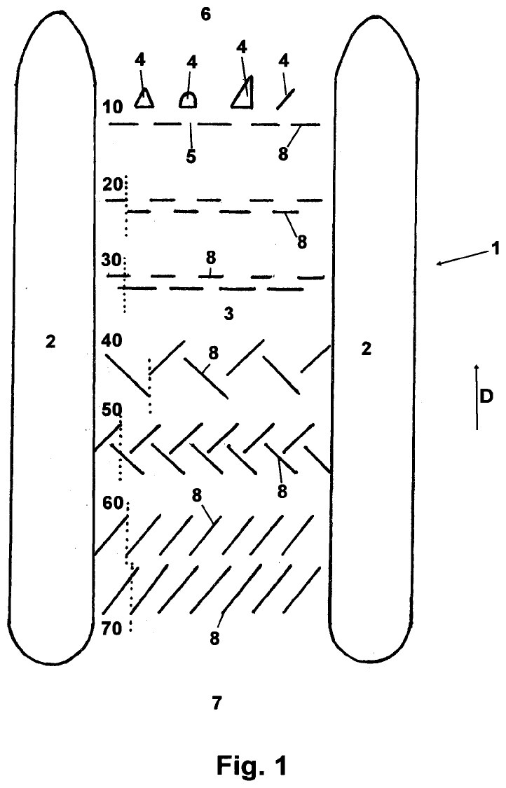

FIG. 1 is a purely schematic illustration of several embodiments of pick-up devices in a ship according to the invention in horizontal section;

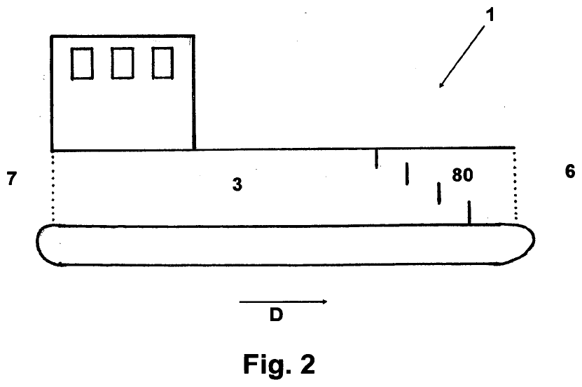

FIG. 2 is a purely schematic illustration of another embodiment of the pick-up devices in a ship according to the invention in longitudinal section;

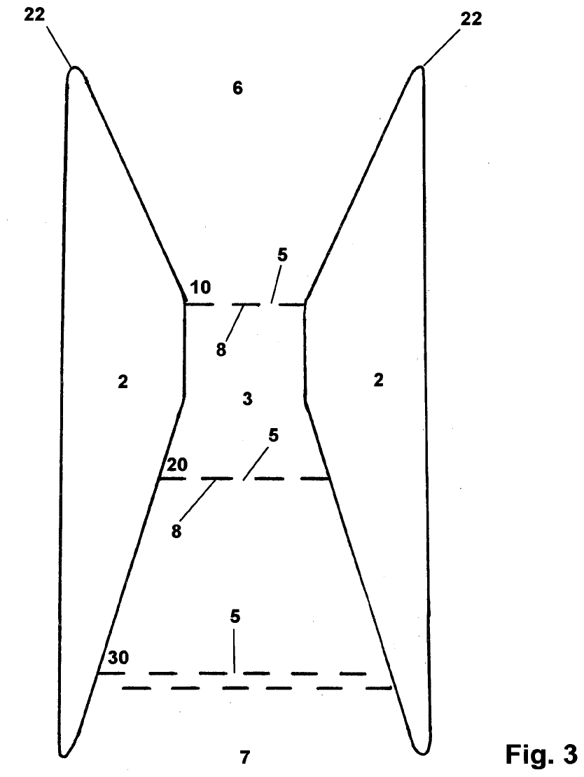

FIG. 3 is a purely schematic illustration of an embodiment of a ship according to the present invention with a basin of reduced width in relation to the width of the captured water layer.

It is specified that the figures show the invention in a purely schematic manner to explain its general mode of operation. The figures are neither to scale nor complete but show schematically only those elements which are necessary to appreciate the invention.

FIG. 1 shows several different possibilities of arranging the pick-up devices 8 in a ship 1 according to the invention in horizontal section. The ship comprises a basin 3 which is confined by the ship's hull 2.

For illustration purposes only, the figure shows several rows of pick-up devices 10, 20, 30, 40, 50, 60, 70, each with a different arrangement.

Row 10 has pick-up devices with spaces between them to allow fish to pass through.

Optionally, the spaces can be covered by beams or hoods or fairings 4 which are positioned at a suitable distance in front of the openings in the row of pick-up devices. The figure shows several shapes of beams or hoods or fairings that are particularly advantageous. The beams or hoods or fairings 4 can, for example, be triangular or rounded in shape. They may also be flat, provided that they are preferably oriented at an angle of about 30° to 60° to the direction of travel of the ship.

The beams or hoods or fairings 4 increase the efficiency of the pick-up devices 8 and at the same time reduce the cost compared to a complete row of pick-up devices over the full widths of the basin.

Fish can easily pass between a beam or hood or fairing 4 and a pick-up device 8 to a space 5 between two pick-up devices. However, the waste is diverted through the beams or hoods or fairings 4 to the pick-up devices 8 and is collected efficiently.

Row 20 is a double row of devices according to row 10, arranged in a staggered manner to allow on the one hand fish to pass and on the other hand to collect all waste, including waste passing through the spaces of the devices further forward in relation to the direction of travel D of the ship.

Row 30 corresponds to row 20, but the pick-up devices are arranged overlapping on their edges.

Rows 40 and 50 have devices that are staggered, without overlapping edges for row 40 and with overlapping edges for row 50.

Rows 60 and 70 have devices which are arranged at an angle to the direction of travel D of the ship, without overlapping edges for row 60 and with overlapping edges for row 70.

FIG. 2 shows an alternative arrangement of the pick-up devices in a ship 1 according to the invention in cross-section. The devices 80 are arranged vertically staggered to allow fish to pass through the spaces between them.

FIG. 3 shows a ship 1 with two side hulls 2 each having a bow tip 22, off-centered outwardly. The width of the hulls increases in the first section of the ship towards the stern 7 of the ship such that the width of basin 3 decreases.

A first row 10 of pick-up devices 8 for picking up large waste is located near the entrance to the basin in the reduced width section. The pick-up devices have spaces between them to allow fish to pass through. At this first row 10 the width of the basin is reduced to the maximum in relation to the width of the captured layer of water L1 between the tips 22 of the hulls 2. The pick-up devices in this section are particularly robust for picking up large objects. They do not offer much resistance to the passage of water. The increase in water speed has no particular effect.

Then there is a second row 20 of pick-up devices 8. The width of the basin in this row 20 is wider than the width in the first row 10 due to the shape of the hulls 2.

The pick-up devices designed to pick up medium-sized objects have a higher resistance to water flow and are more fragile. Therefore, the speed of water flow in the second row should be reduced. There are spaces between the devices for fish to pass through. The spaces are large enough to allow fish and waste that is smaller than the objects that are picked up by the devices in row 20 to pass through.

Towards the stern 7 of the ship, the width of the basin widens even further. Row 30 of pick-up devices is designed to pick up small objects. The devices are arranged in a horizontally staggered arrangement with overlapping edges to allow fish to pass through while still effectively picking up the waste.

Reducing the width of the ship's basin at certain locations allows a considerable reduction in the number of pick-up devices required at these locations, which reduces operating and maintenance costs but allows a considerable width of the water layer to be treated.

1. A ship for recovering ocean waste comprising at least one basin passing through the ship from the bow to the stern,
the basin being open at both ends,
the basin being equipped with at least one row of pick-up devices,
characterized in that
the pick-up devices of at least one row are arranged in such a way that they have openings or spaces between them; and
at least part of the openings or spaces between the pick-up devices are covered by beams or hoods or fairings positioned at a distance in front of the row of pick-up devices.

2. (canceled)

3. A ship for recovering ocean waste comprising
at least one basin passing through the ship from the bow to the stern,
the basin being open at both ends,
the basin being equipped with at least one row of pick-up devices,
characterized in that
the pick-up devices of at least one row are arranged in such a way that they have openings or spaces between them; and the pick-up devices are arranged vertically and/or horizontally staggered, offset or at an angle to the direction of travel of the ship.

4. A ship for recovering ocean waste comprising
at least one basin passing through the ship from the bow to the stern,
the basin being open at both ends,
the basin being equipped with at least one row of pick-up devices,
characterized in that the pick-up devices of at least one row are arranged in such a way that they have openings or spaces between them; and the pick-up devices are arranged overlapping at their edges.

5. Ship according to claim 3, characterized in that the pick-up devices are arranged in a staggered manner, the edges of the devices located further forward overlapping the edges of the devices located behind them and leaving a gap between them.

6. The ship according to claim 1, characterized in that the dimension of the space between the edges of two adjacent devices is less than two meters, and preferably less than one meter.

7. The ship according to claim 1, characterized in that the width of the opening of the basin at the bow of the ship is greater than the width of the basin at the location of at least one row of pick-up devices.

8. The ship according to claim 7, characterized in that the width of the basin at the location of at least one row of pick-up devices corresponds to width of the opening of the basin at the bow of the ship.

9. The ship according to claim 1, characterized in that the basin comprises at least two successive sections from the bow to the stern of the ship, the pick-up devices of each section being capable of picking up objects of a different size range, the sections being arranged in such a way that a device capable of picking up smaller objects is arranged behind a device capable of picking up larger objects in relation to the direction of travel of the ship.

10. The ship according to claim 1, characterized in that the pick-up devices are held and guided by means of supports, in particular by means of cables, chains, tubes and/or beams, profiled or non-profiled.

11. The ship according to claim 10, characterized in that the pick-up devices are wholly or partly composed of nets or latticework and are equipped with rings or other fastening devices enabling them to slide or move along the supports.

12. The ship according to claim 1, characterized in that the propulsion of the ship is diesel-electric hybrid hydrogen powered working in whole or in part by hydrogen.

13. The ship according to claim 1, characterized in that the ship is equipped with one or more engines running on hydrogen.

14. The ship according to claim 13, characterized in that the hydrogen necessary for the operation of the engine(s) is produced on board, in particular by means of a power unit, fuel or solar batteries, feeding an electrolyzer which injects hydrogen directly or indirectly into the engine(s).

15. The ship according to claim 14, characterized in that the hydrogen is produced as and when required.

16. The ship according to claim 15, characterized in that the production capacity of the hydrogen production device is sufficient to inject at least 50% of the hydrogen required for the operation of the engine(s), preferably at least 70%, and advantageously at least 100% of the hydrogen required.

17. The ship according to claim 1, characterized in that it is equipped with water jet propulsion means.

18. The ship according to claim 1, characterized in that the ship comprises at least one device for treating marine animals classified occasionally or temporarily as pests, in particular jellyfish.

19. The ship according to claim 18, characterized in that at least one treatment device is equipped with a high-temperature heating device.

20. The ship according to claim 1, characterized in that it has at least one electronic device for displaying images or video films in the form of a flat, convex, concave, spherical or otherwise shaped panel or screen.

21. The ship according to claim 20, characterized in that the panel or screen is retractable or can be stored in a protective housing, or is equipped with a retractable or removable protective watertight cover.

22. (canceled)
